(19) United States
(12) Patent Application Publication
(10) Pub. No.: US 2008/0082206 A1
(43) Pub. Date: Apr. 3, 2008

(54) Automated conveying system

(75) Inventors: Kengo Egami, Iruma City (JP); Kevin M. Hull, Gurnee, IL (US); Shuji Matsumoto, Gurnee, IL (US); William M. Faber, Gurnee, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Yaskawa Electric America, Inc.

(21) Appl. No.: 11/904,935

(22) Filed: Sep. 27, 2007

Related U.S. Application Data
(60) Provisional application No. 60/847,756, filed on Sep. 28, 2006.

(51) Int. Cl. G06F 7/00

(52) U.S. Cl. 700/230

(57) ABSTRACT

An automated control system is described for a conveying system including an input conveyor supplying a product, a segmented output conveyor delivering a product in a pattern, and one or more synchronizing conveyors disposed between the input conveyor and the output conveyor. The control system comprises a plurality of product position sensors for sensing position of product on each synchronizing conveyor. A conveyor sensor senses segment position of the output conveyor. A plurality of drives, one for each respective conveyor, control the respective conveyors. A database stores a plurality of template pattern algorithms each defining a control algorithm for a distinct product pattern to be delivered from the segmented output conveyor. A controller is operatively connected to the product position sensors, the conveyor sensor and the drives for controlling the conveyors responsive to sensed product position and segment position. The controller includes a programmable processor operable to download a select one of the template pattern algorithms. The controller selectively advances or retards product position relative to the segment position of the output conveyor to release the products onto the output conveyor according to the distinct product pattern defined by the downloaded template pattern algorithm.

### CROSS REFERENCE TO RELATED APPLICATIONS

This application claims priority of provisional application No. 60/847,756 filed Sep. 28, 2006.

### FIELD OF THE INVENTION

This invention relates to automated conveying systems and, more particularly, to use of template pattern algorithms to define a desired output pattern.

### BACKGROUND OF THE INVENTION

A conventional arrayed conveyor system, in one form, is composed of an input conveyor supplying a product, an output conveyor delivering the product and one or more variable speed conveyors between the input conveyor and the output conveyor for performing product position correction. The speed of the output conveyor is fixed and the standard speed of the variable speed conveyor is set to the same speed as the output conveyor. The speed of the variable speed conveyor is assumed to be a select standard speed except when position correction is being implemented.

With such a conveying system, the speed of the input conveyor is set slower than the select standard speed of the variable speed conveyor. This is so that products will be separated when products are supplied in a contracted state from the input conveyor. Also, the position correction for products on the variable speed conveyor is implemented by calculating the distance from the current position to the output conveyor transport, and the position correction from the target position in the output conveyor. The correction is performed by dividing this correction amount among each of the arrayed variable speed conveyors. The direction of this position correction performs correction only in a forward direction. In other words, the correction speeds up the variable speed conveyor system. Moreover, in determining the position correction amount, the amount is calculated in consideration of the maximum speed of the variable speed conveyor.

The described automated conveying system has limited flexibility. The system accumulates product from the input conveyor and varies time spent on the synchronizing conveyor to deliver the product to the output conveyor. Such a system produces a generally fixed output.

The present invention is directed to improvements in automated conveying systems.

### SUMMARY OF THE INVENTION

In accordance with the invention, there is provided an automated conveying system providing a plurality of distinct product output patterns.

In accordance with one aspect of the invention, there is provided an automated control system for a conveying system including an input conveyor supplying a product, a segmented output conveyor delivering a product in a pattern, and one or more synchronizing conveyors disposed between the input conveyor and the output conveyor. The control system comprises a plurality of product position sensors for sensing position of product on each synchronizing conveyor. A conveyor sensor senses segment position of the output conveyor. A plurality of drives, one for each respective conveyor, control the respective conveyors. A database stores a plurality of template pattern algorithms each defining a control algorithm for a distinct product pattern to be delivered from the segmented output conveyor. A controller is operatively connected to the product position sensors, the conveyor sensor and the drives for controlling the conveyors responsive to sensed product position and segment position. The controller includes a programmable processor operable in accordance with a select downloaded one of the template pattern algorithms to selectively advance or retard product position relative to the segment position of the output conveyor to release the products onto the output conveyor according to the selected one of the template pattern algorithms.

It is a feature of the invention that the plurality of template pattern algorithms are selected from a group consisting of skip mode, fill all mode, lane merge mode and group mode.

It is another feature of the invention that the fill all mode is selected from one of a variable output feed mode and a constant output feed mode.

It is another feature of the invention that the processor is operable to compare the product position to the segment position and determine a position correction and to utilize the position correction to vary position of the conveyors to advance or retard product position.

One of the template pattern algorithms may comprise a skip mode wherein the output conveyor is driven at constant speed and every product is phased onto the output conveyor at a segment of the output conveyor.

One of the template pattern algorithms may comprise a fill all mode wherein the output conveyor is driven to control output conveyor position and every product is phased onto the output conveyor and every segment of the output conveyor receives the product.

One of the template pattern algorithms may comprise a group mode wherein every product is phased onto the output conveyor and select groups of segments of the output conveyor receive the product and select segments of the output conveyor do not receive the product.

One of the template pattern algorithms may comprise a lane merge mode wherein products from a plurality of parallel feed conveyors are merged onto the output conveyor.

One of the template pattern algorithms may comprise a fill all mode wherein the output conveyor is driven at constant speed and every product is phased onto the output conveyor and every segment of the output conveyor receives the product.

It is a further feature of the invention that the processor implements an adaptive position-based motion profile-generating algorithm that senses product position, and dynamically controls the position of the product as it passes through the conveying system.

It is another feature of the invention that the adaptive position-based motion profile-generating algorithm tracks line speed of the input conveyor or the output conveyor, respectively, during transitions to prevent slip or loss of track position.

It is yet another feature of the invention that the processor dynamically tracks current position of each product.

Further features and advantages of the invention will be readily apparent from the specification and from the drawings.

### BRIEF DESCRIPTION OF THE DRAWINGS

FIG. 1 is a functional block diagram of an automated conveying system in accordance with the invention;

FIG. 2 is a mechanical diagram of an automated conveyor system in accordance with an exemplary embodiment of the invention;

FIG. 3 is a flow diagram illustrating a control algorithm implemented in the machine controller of FIG. 2;

FIG. 4 is a flow diagram of a position correction algorithm utilized in the control algorithm of FIG. 3;

FIG. 5 is a partial mechanical diagram of the automated conveyor system illustrating relevant distances used in the flow diagram of FIG. 4;

FIG. 6 is a mechanical diagram illustrating operation of a skip mode; and

FIG. 7 is a mechanical diagram illustrating operation of a fill all mode.

### DETAILED DESCRIPTION OF THE INVENTION

In accordance with the invention, an automated conveying system uses one or more position controlled conveyance device(s), in series or parallel combinations, that accept randomly spaced product as an input. The system uniquely controls the products relational position by advancing and/or retarding the product position, and then releases the products onto an output conveyor in a desired output pattern. The final output pattern depends on the type of a selected template pattern.

As used herein, conveyance device is defined as any device or series of devices that transfer product from one location to another, and could include belts, rollers, or other technologies. This document generalizes conveyance devices and will use the term “conveyor” throughout to simplify the description. Servo controlled is defined as any closed loop system that takes feedback to adjust a command reference. The conveyance device may comprise a servo controlled conveyance device, as described herein, or a variable frequency drive, or the like, as will be apparent.

Because of the various types of applications used in the automation industry, the present invention is directed to segmenting conveying system implementations into distinct application template patterns. The automated conveying system described herein may use any one of five different pre-defined template patterns that run on a motion control hardware platform. Included is pre-configured software code for position based correction and access to template pattern control algorithms stored in a database.

Randomly spaced product can enter the automated conveying system in many different ways: front-to-back touching with no space, consistent spacing, variable spacing, or any combination thereof. Product size can be fixed length or variable length within defined limits. The automated conveying system includes unique controls that include an adaptive position-based motion profile-generating algorithm that senses product position, and dynamically controls the position of the product as it enters and passes through the servo controlled system.

The following characteristics of the algorithm make this system unique. The system registers the position of incoming product onto each servo-controlled conveyor and buffers the registration position for future calculation events. The system also dynamically tracks the current position of each product. These two features make it possible for multiple products to be present on a single servo controlled conveyor at one time, and reduces the number of conveyors required for any given application. The control algorithm makes decisions on how to adjust the position of the products based on system goals and output pattern constraints. It will primarily advance the product position to reduce product build-up on the in-feed, and improve overall system throughput goals. It will secondarily retard the product if the output pattern constraints require it.

Because of the control algorithm's position based characteristics, the system does not require accumulation of the in-feed, and in-feed can be random. Product will move through the system at a base speed equal to speed of the output conveyor. When product is transitioning into or out of the servo-controlled system, the speed of the system will match the line speed of the input or downstream conveyors respectively to prevent slip or loss of tracked position when the product is transitioning. The control algorithm calculates and controls the products position by advancing and retarding the position in relation to the master position, in an optimized motion profile, referred to herein as smooth path mode. This motion profile may be as disclosed in International Application No. PCT/JP2006/321494, corresponding to Publication no. WO/2007/055112, the specification of which is incorporated by reference herein. The optimization occurs when the system evaluates various parameterized constraints and system requirements, and calculates the position trajectory for the smoothest and quickest adjustment motion profile. Parameterized constraints & requirements include: product size, conveyor length, defined adjustment zone, max acceleration, throughput requirements, desired output pattern. The result of this optimized motion profile reduces system shock and mechanical wear, as well as increases throughput of products though the system. The optimized motion profile is calculated based on conveyor and product characteristics that limit the acceleration level when advancing or retarding the products position. This acceleration limit (+ or −) prevents product slip and maintains maximum throughput.

Product will be released onto the output conveyor in a pattern determined by the specific template pattern chosen. All template patterns are empowered by the disclosed motion profile control algorithm technology. In the illustrated embodiment of the invention, there are five different solution packages or modes that define specific output patterns, with a sixth mode being applicable when using customization services. As is apparent, an automated conveying system in accordance with the invention could have access to less than all of the disclosed template patterns, and could use alternative template patterns. The disclosed template patterns include: Skip mode; Fill all mode with variable out-feed; Fill all mode with constant out-feed; Group mode; Lane merge mode; and Custom pattern mode.

The disclosed automatic conveyor system uses a suite of pre-engineered application modules designed to automate product phasing onto conveyors. The application modules are flexible and the programs can be modified to accommodate unique features of machine designs. The application modules are in the form of template patterns, as described above. Each template pattern is characterized as a particular mode of operation. With a skip mode, an output conveyor runs at constant speed. Every part is phased onto the output conveyor, but every position may or may not be filled. With a fill all mode, the output conveyor speed is modulated using the smooth path mode algorithm. Every product is phased and every position is filled. With a group mode, also referred to as fill all with programmable gapping, gapping features are added to the fill all mode. This function can be as simple as providing a fixed gap between products, to as complex as pattern developments. An example is a program developed for case packers. The system builds grouping of precisely spaced products to provide the desired fill pattern for the cases. The different gap length is provided between groups to allow for product to be inserted into the cases. In some applications, this function eliminates the need for the mechanical “train” on the machine. The lane merge module is used where products from two or three feed conveyors are merged onto a single output conveyor. Products are uniformly spaced and can be phased on the output conveyor. A fill all with constant speed output conveyor module is similar to the fill all mode, discussed above, except that the output conveyor runs at a constant speed.

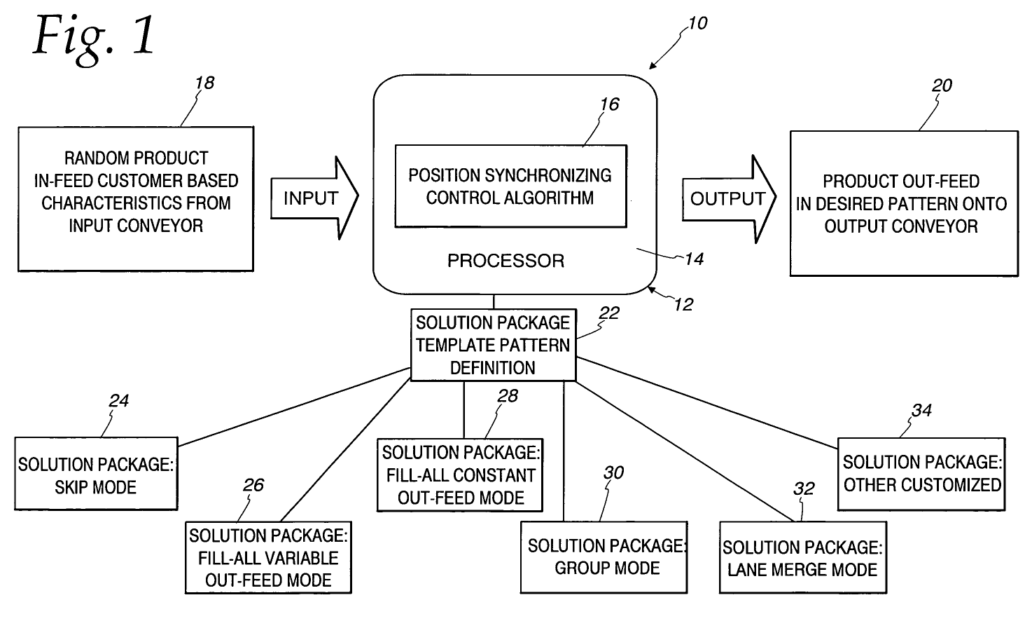

Referring to FIG. 1, a generalized block diagram illustrates an automated control system 10 for a conveying system, described below. The automated control system includes a controller 12 comprising a processor 14 and memory 16. The controller 12 receives as input random product in-feed having customer based characteristics from an input conveyor represented by a block 18 and develops as output product out-feed in a desired pattern onto an output conveyor at a block 20. The memory 16 stores a position synchronizing control algorithm for controlling operation. The control algorithm utilizes one of a plurality of solution package template pattern algorithms downloaded from a database 22. Each template pattern algorithm is a control algorithm for a distinct product pattern to be delivered from the output conveyor. Particularly, the control system 10 downloads a select one of the plurality of template pattern algorithms which implement one of a skip mode at a database memory 24, fill all variable out-feed mode at a database memory 26, fill all constant out-feed mode at a database memory 28, group mode at a database memory 30, lane merge mode at a database memory 32 and a customized mode at a database memory 34. Each of the modes operates in accordance with that generally discussed above. As will be apparent, any of the memories mentioned above may consist of a RAM memory or the like, a hard disk memory, optical memory, or any storage device accessible by programmable processing systems. Moreover, the database 22 may be remotely located relative to the controller 12, may be co-located with the controller 12 or may be integrated with the controller 12. In an exemplary embodiment of the invention, the database 12 is remotely located and a particular template pattern algorithm may be downloaded via appropriate network connections, in any conventional manner.

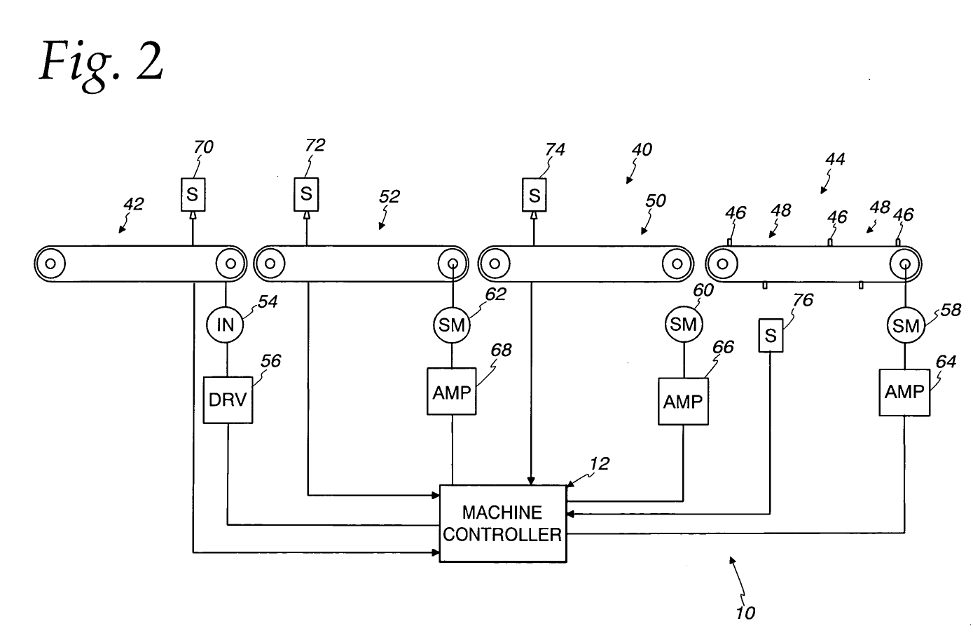

Referring to FIG. 2, a mechanical diagram illustrates an exemplary conveying system 40 including the automated control system 10 in accordance with the invention. An input conveyor 42 supplies a product. An output conveyor 44 delivers the product in a pattern. Particularly, the output conveyor 44 may be a flighted or cleated conveyor, or the like, including flaps 46, or the like, spaced at equal intervals to define a segmented output conveyor. Particularly, the space or segment 48 between each set of flaps 46 is intended to receive a product. As is apparent, if the output conveyor does not include flaps, then the system may use “virtual segments” corresponding to select product intervals to define a segmented output conveyor. In accordance with the particular template pattern used, every segment 48 may be filled or select segments may be filled in groups, or the like, as will be apparent.

The conveying system 40 includes a first synchronizing conveyor 50 and a second synchronizing conveyor 52. The conveyors are mounted in series so that the input conveyor 42 delivers product to the second synchronizing conveyor 52 which delivers product to the first synchronizing conveyor 50 which delivers product to the output conveyor 40. Alternatively, conveyors could be provided in parallel for delivering products to the output conveyor 44, as is known. As will be apparent, the relationship between conveyors shown and described herein is by way of example only. The control system 10 could be used with various different conveyor configurations.

The input conveyor 42 is driven by an induction motor 54 controlled by an AC drive 56 controlled by the controller 12. The output conveyor 44, first synchronizing conveyor 50 and second synchronizing conveyor 52 are controlled by respective servomotors 58, 60 and 62 driven by respective servo amps 64, 66 and 68. Each of the servo amps 64, 66 and 68 is controlled by the machine controller 12. An optional first product position sensor 70 senses position of product on the input conveyor 42 and is connected to the machine controller 12. A second product position sensor 72 senses product at a known position on the second synchronizing conveyor 52 and is connected to the machine controller 12. A third product position sensor 74 senses position of product on the first synchronizing conveyor 50 and is connected to the machine controller 12. Finally, a conveyor sensor 76 senses segment position of the output conveyor and is connected to the machine controller 12. Particularly, the conveyor sensor 76 senses position of the flaps 46.

In accordance with the invention, the controller 12 selectively controls position of the synchronizing conveyors 50 and 52, and optionally the output conveyor 44 responsive to sensed product position and segment position. The controller 12 selectively advances or retards product position relative to the segment position of the output conveyor 44 to release the products onto the output conveyor according to a selected one of the template pattern algorithms. Particularly, the controller 12 using the smooth path mode algorithm continually calculates a new commanded position. In an illustrative embodiment of the invention, these calculations occur about 500 times per second. By this activity, the servo is commanded to advance, as required, a desired amount typically represented in encoder pulses. An encoder pulse corresponds to an incremental movement of the conveyor, as is known. The result of the position corrections appears as a speed change. Indeed the conveyors may move at constant speed, accelerate or decelerate, depending on the required correction.

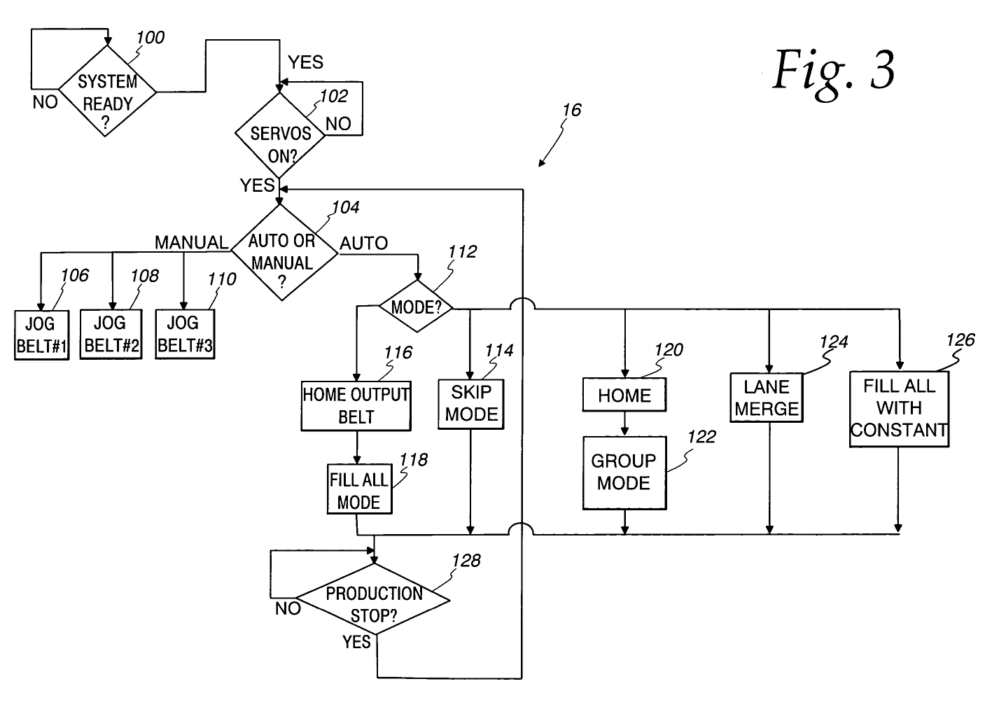

Referring to FIG. 3, a flow diagram illustrates operation of the position synchronizing control algorithm 16, see FIG. 1. The algorithm begins at a decision block 100 and waits for the system to be ready. Once the system is ready, then a decision block 102 determines if the servos 58, 60 and 62 are on. If not, the system waits. Thereafter, a decision block 104 determines if the controller is in an auto or manual mode. If manual mode, then the user can jog the first synchronizing conveyor 50 at a block 106, jog the second synchronizing conveyor 52 at a block 108 or jog the output conveyor 44 at a block 110.

If the control algorithm is in the auto mode, then the control algorithm used depends on which template pattern algorithm has been downloaded from the database 22. A decision block 112 determines which mode of operation has been downloaded by the user. If the skip mode is used, then the skip mode is implemented at a block 114. With the skip mode, the output conveyor 44 is operated at constant speed. As a result, some segments 48 will not have product. The synchronizing conveyors 50 and 52 are controlled to position the product on the output conveyor 44. Each synchronizing conveyor 50 or 52 is controlled to make the maximum correction possible within the limitations of the mechanical design and product requirements.

With the fill all mode, the output conveyor 44 is first positioned at a home position at a block 116. Thereafter, the fill all mode is implemented at a block 118. With the fill all mode, the output conveyor 44 is operated in the smooth path mode, but can switch to constant speed based on product flow. The output conveyor 44 and synchronizing conveyors 50 and 52 work together to optimize the motion of all axes.

With group mode, the output conveyor 44 is initially moved to a home position at a block 120. The group mode is then implemented at a block 122. The group mode is discussed above. Likewise, the control can implement the lane merge mode at a block 124 or the fill all with constant output speed at a block 126. During any of the control modes, a decision block 128 determines if a production stop has been requested. If not, then the particular mode of operation continues.

As is apparent, each of the modes defines a select pattern of product placement on the output conveyor 44, as discussed above. Position of the output conveyor 44 is known to the controller 12 by the reference position information provided by the conveyor sensor 76 sensing one of the flaps 46 and otherwise from position information from the servomotor 58 between flaps 46. However, products may be randomly spaced on the input conveyor 42. The ability to transfer multiple products, on each conveyor, eliminates the need to modulate the speed of the input conveyor 42. The synchronizing conveyors 50 and 52, and optionally the output conveyor 44, are position controlled, as described above, to selectively retard or advance product position so that the product is at a desired position when transferred from the first synchronizing conveyor 50 to the output conveyor 44.

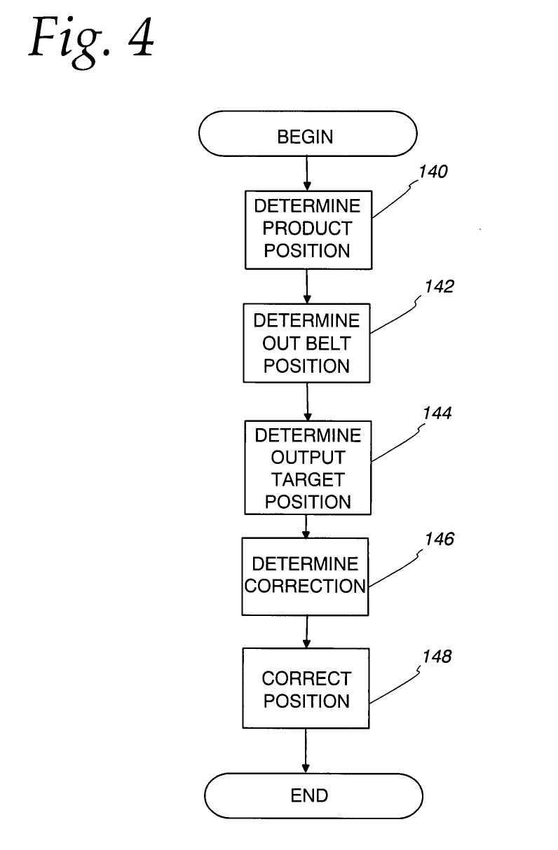

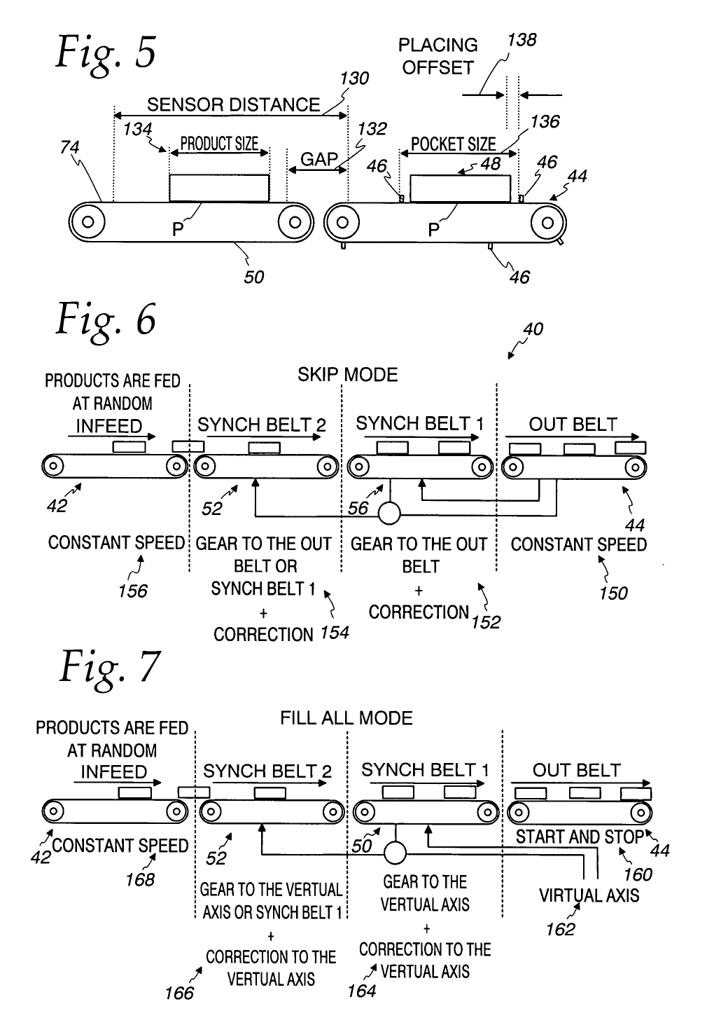

The smooth mode algorithm for position correction, implemented in each of the modes discussed in FIG. 3, is shown in FIG. 4. This makes use of various positional information generally illustrated in FIG. 5 between the output conveyor 44 and the synchronizing conveyor 50. Some of these distances are fixed based on hardware configuration, while others are fixed based on product sizes and/or desired spacing. This information includes a sensor distance 130 representing distance between the first synchronizing conveyor product sensor 74 and a known position of the output conveyor 44, such as an axis position. A gap 132 represents spacing between known positions on the output conveyor 44 and the first synchronizing conveyor 50. The product size is shown at 134. A pocket size 136 represents segment size between flaps 46 on the output conveyor 44. Finally, a placing offset 138 represents desired gap between a product P and a forward most flap 46 when the product P is positioned within a segment 48. Similar dimensional relationships exist between any adjacent conveyors, as is apparent.

Each conveyor tracks a product position in its own area of product tracking memory. As the particular conveyor is making a correction for the lead product, updates are made to an originally stored position of each subsequent product on the particular conveyor. When a product becomes the lead product on a conveyor, the controller 12 then has the ability to make the required correction given that the product relationship with the output conveyor 44 may have changed since its position was sensed.

Returning to the flow diagram of FIG. 4, the routine begins by determining product position at a block 140. The product position is optionally initially determined by the first product position sensor 70, if present, and otherwise by the second and third product position sensors 72 and 74. Knowing these reference positions and incremental changes in position based on feedback form the servomotors, the precise product position can be tracked at any given time, as described. Segment position for the output conveyor 44 is determined at a decision block 142, as discussed above. A block 144 determines an output target position. This represents which segment and where within the segment using the pocket size 136, and placing offset 138, relative to the product size 134, the product needs to reach on the output conveyor 44. A block 146 determines a correction representing where the product needs to be positioned relative to its current position as determined at the block 140. A block 148 corrects position by selectively advancing or retarding product position. How this is implemented depends on the mode of operation being utilized. If output conveyor speed is constant, then the product position can be advanced or retarded by the smooth path mode algorithm controlling either or both of the synchronizing conveyors 50 and 52, as previously described. As such, the controller 12 dynamically controls the position of the product as it enters and passes through the conveying system 40.

In accordance with the invention, changes in position are controlled by limiting acceleration and deceleration to minimize slippage or loss of track position on any of the conveyors. Particularly, in order to prevent slip or loss of track position, the line speed of the first synchronizing conveyor 50 is matched to the output conveyor 44 for transfer of product therebetween. Likewise, line speed of the second synchronizing conveyor 52 is matched to line speed of the input conveyor 42 to receive product therefrom. Finally, the line speed of the first synchronizing conveyor 50 is matched to the second synchronizing conveyor 52 to receive product therefrom. Because of the nature of the product tracking algorithm, changes in speed caused by the upstream conveyors will reflect a change in product relationship with the output conveyor 44.

Operation of the conveying system 40 using the skip mode is illustrated in FIG. 6. With the skip mode, the output conveyor 44 operates at constant speed as illustrated at 150. The first synchronizing conveyor 52 is “geared” to the output conveyor 44 plus any required correction. The “gearing” is virtual in nature as it is provided by controlling the first synchronizing conveyor servomotor 60, see FIG. 2, to essentially match speed of the output conveyor 44 plus or minus any correction to advance or retard product position. As illustrated at 154, the second synchronizing conveyor 52 is “geared” to the output conveyor 44 or the first synchronizing conveyor 50 plus any correction. The input conveyor 42 is operated at constant speed as at 156.

FIG. 7 illustrates a control outline for the fill all mode. The output conveyor 44 can be started and stopped, as necessary as illustrated at 160. Because the output conveyor 44 is not operated at constant speed, the system uses a “virtual” axis 162 representing a virtual position. The output conveyor 44 can be started and stopped, or position controlled, as necessary, to position each product accurately responsive to this virtual axis. As indicated at 164, the first synchronizing conveyor 50 is “geared” to the virtual axis and correction to the virtual axis. As indicated at 166, the second synchronizing conveyor 52 is “geared” to the virtual axis 162 or the first synchronizing conveyor 50 plus correction to the virtual axis. The input conveyor 42 is operated at constant speed as indicated at 168.

The remaining modes are offsets of the skip mode and fill all mode, as discussed above. Operation will be generally similar.

The automated control system described herein provides the user with a system that can be customized to meet application requirements. The system is complete with the program, control signal assignments and variables necessary for a synchronizing conveyor system. Setting machine constants, downloading a template pattern algorithm and providing necessary IO signals are the only steps required for operation. As is apparent, different numbers of synchronizing conveyors could be used, as necessary or desired. The system is designed for random in-feed application and is ideal for packaging industry and suitable for applications such as case packers, cartoners, flow wrappers, package sorters, etc.

Thus, in accordance with the invention, there is provided a system which operates in accordance with a selected one of a plurality of template patterns to selectively advance or retard product position by controlling the conveyors to advance or retard product position relative to segment position of an output conveyor to release the products onto the output conveyor according to a selected one of a plurality of template patterns.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

We claim:

1. An automated control system for a conveying system including an input conveyor supplying a product, a segmented output conveyor delivering a product in a pattern, and one or more synchronizing conveyors disposed between the input conveyor and the output conveyor, the control system comprising:
a product position sensor for each synchronizing conveyor for sensing position of product on each synchronizing conveyor;
a conveyor sensor for sensing segment position of the output conveyor;
a plurality of drives, one for each respective conveyor, for controlling the respective conveyor;
a database storing a plurality of template pattern algorithms each defining a control algorithm for a distinct product pattern to be delivered from the segmented output conveyor; and
a controller operatively connected to the product position sensors, the conveyor sensor and the drives for controlling the conveyors responsive to sensed product position and segment position, the controller including a programmable processor, the processor being operable to download a select one of the template pattern algorithms, whereby the controller selectively advances or retards product position relative to the segment position of the output conveyor to release the products onto the output conveyor according to the distinct product pattern defined by the downloaded template pattern algorithm.

2. The automated control system of claim 1 wherein the plurality of template pattern algorithms are selected from a group consisting of skip mode, fill all mode, lane merge mode and group mode.

3. The automated control system of claim 2 wherein the fill all mode is selected from one of a variable output feed mode and a constant output feed mode.

4. The automated control system of claim 1 wherein the processor is operable to compare the product position to the segment position and determine a position correction, and to utilize the position correction to vary position of the conveyors to advance or retard product position.

5. The automated control system of claim 1 wherein one of the template pattern algorithms comprises a skip mode wherein the output conveyor is driven at constant speed and every product is phased onto the output conveyor at a segment of the output conveyor.

6. The automated control system of claim 1 wherein one of the template pattern algorithms comprises a fill all mode wherein the output conveyor is driven to control output conveyor position and every product is phased onto the output conveyor and every segment of the output conveyor receives the product.

7. The automated control system of claim 1 wherein one of the template pattern algorithms comprises a group mode wherein every product is phased onto the output conveyor and select groups of segments of the output conveyor receive the product and select segments of the output conveyor do not receive the product.

8. The automated control system of claim 1 wherein one of the template pattern algorithms comprises a lane merge mode wherein product from a plurality of parallel feed conveyors are merged into the output conveyor.

9. The automated control system of claim 1 wherein one of the template pattern algorithms comprises a fill all mode wherein the output conveyor is driven at constant speed and every product is phased onto the output conveyor and every segment of the output conveyor receives the product.

10. The automated control system of claim 1 wherein the processor implements an adaptive position-based motion profile-generating algorithm that senses product position, and dynamically controls the position of the product as it passes through the conveying system.

11. In a conveying system including a random feed input conveyor supplying a product, a segmented output conveyor delivering a product, and one or more synchronizing conveyors disposed between the input conveyor and the output conveyor, an improved control system comprising:
a product position sensor for each synchronizing conveyor for sensing position of product on each synchronizing conveyor;
a conveyor sensor for sensing segment position of the output conveyor;
a plurality of drives, one for each respective conveyor, for controlling the respective conveyor;
a database storing a plurality of template pattern algorithms each defining a control algorithm for a distinct product pattern to be delivered from the segmented output conveyor; and
a controller operatively connected to the product position sensors, the conveyor sensor and the drives for controlling the conveyors responsive to sensed product position and segment position, the controller including a programmable processor, the processor being operable to download a select one of the template pattern algorithms, whereby the controller selectively advances or retards product position relative to the segment position of the output conveyor to release the products onto the output conveyor according to the distinct product pattern defined by the downloaded template pattern algorithm.

12. The improved control system of claim 11 wherein the plurality of template pattern algorithms are selected from a group consisting of skip mode, fill all mode, lane merge mode and group mode.

13. The improved control system of claim 12 wherein the fill all mode is selected from one of a variable output feed mode and a constant output feed mode.

14. The improved control system of claim 11 wherein the processor is operable to compare the product position to the segment position and determine a position correction, and to utilize the position correction to vary position of the conveyors to advance or retard product position.

15. The improved control system of claim 11 wherein one of the template pattern algorithms comprises a skip mode wherein the output conveyor is driven at constant speed and every product is phased onto the output conveyor at a segment of the output conveyor.

16. The improved control system of claim 11 wherein one of the template pattern algorithms comprises a fill all mode wherein the output conveyor is driven at control output conveyor position and every product is phased onto the output conveyor and every segment of the output conveyor receives the product.

17. The improved control system of claim 11 wherein one of the template pattern algorithms comprises a group mode wherein every product is phased onto the output conveyor and select groups of segments of the output conveyor receive the product and select segments of the output conveyor do not receive the product.

18. The improved control system of claim 11 wherein one of the template pattern algorithms comprises a lane merge mode wherein product from a plurality of parallel feed conveyors are merged into the output conveyor.

19. The improved control system of claim 11 wherein one of the template pattern algorithms comprises a fill all mode wherein the output conveyor is driven at constant speed and every product is phased onto the output conveyor and every segment of the output conveyor receives the product.

20. The improved control system of claim 11 wherein the processor implements an adaptive position-based motion profile-generating algorithm that senses product position, and dynamically controls the position of the product as it passes through the conveying system.

21. The improved control system of claim 20 wherein the adaptive position-based motion profile-generating algorithm tracks line speed of the input conveyor or the output conveyor, respectively, when product is transferring from the input conveyor or to the output conveyor to prevent slip or loss of tracked position.

22. The improved control system of claim 11 wherein the processor dynamically tracks current position of each product.
